(19) United States
(12) Patent Application Publication
(10) Pub. No.: US 2025/0122098 A1
(43) Pub. Date: Apr. 17, 2025

(54) PREPARATION METHOD FOR POSITIVE ELECTRODE MATERIAL PRECURSOR HAVING LARGE CHANNEL, AND APPLICATION THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING Co., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/685,240

(22) PCT Filed: Nov. 30, 2022
(86) PCT No.: PCT/CN2022/135660

§ 371 Date: Feb. 21, 2024

(30) Foreign Application Priority Data
Jan. 24, 2022 (CN) 202210077149.4

(51) Int. Cl. C01G 53/506

(52) U.S. Cl. CPC C01G 53/506; C01P 2004/03; C01P 2006/40

(57) ABSTRACT

The present application provides a preparation method for a positive electrode material precursor having a large channel, and an application thereof. The method comprises: mixing a sodium hexanitrocobaltate aqueous solution, a nickel-manganese mixed salt solution, an oxalic acid solution, and aqueous ammonia for reaction; calcining a solid material; and soaking the calcined material in water to obtain a positive electrode material precursor having a large channel. According to the present application, nickel-cobalt-manganese and sodium-ammonium are co-precipitated and sintered, and then sodium-ammonium is removed; and since the radius of sodium ions is greater than the radius of lithium ions, a large ion channel is left in a nickel-cobalt-manganese precursor framework, thereby facilitating the deintercalation of the lithium ions of a chemically sintered positive electrode material, widening a lithium ion diffusion channel, and remarkably improving the rate capability and the cycle performance of the material.

### TECHNICAL FIELD

The present disclosure belongs to the technical field of lithium-ion battery (LIB) cathode materials, and in particular relates to a preparation method for an LIB cathode material precursor with a large channel.

### BACKGROUND

LIBs are widely used in fields such as portable electronic products, electric vehicles, and energy storage systems due to their advantages such as high energy density, low self-discharge, no memory effect, long cycling life, and small environmental pollution. With the increasing market demand for high-performance (such as high energy density) batteries and the continuous popularization of electric vehicles, the market demand for battery cathode materials has presented a rapid growth trend. Ternary cathode materials are the most potential and promising materials among the current mass-produced cathode materials due to their characteristics such as high energy density, relatively-low cost, and excellent cycling performance.

The continuous intercalation and deintercalation of Li ions in a battery requires a cathode material to have relatively strong physical and chemical stability. Physical stability: a cathode material and an anode material are required to show structural stability during an electric conduction process and a charge-discharge process, that is, those materials each need to have an ion channel to ensure the smooth migration of Li ions, and also need to have the ability to prevent hole collapse during the deintercalation of Li ions, especially when a battery generates heat to get a high temperature after continuous charging and discharging. Chemical stability: as a temperature or a humidity in a battery changes, each component of an electrode material still maintains a preferable shape without affecting the intercalation, deintercalation, and transportation of Li ions. Therefore, it is of great significance to prepare a lithium battery cathode material with high physical and chemical stability.

At present, there are many methods to improve the cycling performance of ternary LIBs, for example, an LIB ternary (NCM) cathode material is improved by doping and coating to slow down the deterioration of a crystal structure of the cathode material during a cycling process. Although properly doping and coating a cathode material can reduce the contact between a cathode active material and an electrolyte to prevent the dissolution of the cathode material and can inhibit the decomposition of the electrolyte at a high electric potential, an ion channel of the cathode material cannot be changed. In addition, most of materials used for coating do not have the ability to accommodate lithium ions, and too-much coating will reduce a specific capacity of a cathode material.

A preparation method for an LIB cathode material in which LiV₃O₈ and LiNi_{0.4}Co_{0.2}Mn_{0.4}O₂ are blended for modification is disclosed in the related art. The cathode materials LiV₃O₈ and LiNi_{0.4}Co_{0.2}Mn_{0.4}O₂ are mixed in a mass ratio of 3:7 in a three-dimensional (3D) cone mixer, pre-sintered at 480° C. to 500° C. for 2 h, sintered at 650° C. to 675° C. for 4 h, sintered at 800° C. to 825° C. for 6 h, kept at the temperature for 8 h, then naturally cooled with a furnace, and crushed to finally obtain a blended material (LiV₃O₈ and LiNi_{0.4}Co_{0.2}Mn_{0.4}O₂). A ternary cathode material is blended with LiV₃O₈ for modification to obtain a cathode material with high compacted density, which can effectively improve the capacity performance according to test results. However, the simple physical mixing destroys a matrix structure of the ternary cathode material, and no chemical bond is generated between the mixed components, which is not conducive to the construction of a lithium ion channel.

In addition, the performance of a ternary LIB cathode material is 60% dependent on the performance of a precursor thereof, and there are few studies on the synthesis of the precursor to improve the performance of the cathode material.

### SUMMARY

The following is a summary of the subject matters described in detail herein. This summary is not intended to limit the scope of protection of claims.

The present disclosure provides a preparation method for a cathode material precursor with a large channel and use thereof. A precursor prepared by the method has a relatively large ion channel, which is conducive to the improvement of the performance of a subsequently-sintered cathode material.

According to an aspect of the present disclosure, a preparation method for a cathode material precursor with a large channel is provided, including the following steps:
S1: mixing a sodium hexanitrocobaltate aqueous solution, a nickel-manganese mixed salt solution, an oxalic acid solution, and aqueous ammonia to allow a reaction at a controlled temperature, a controlled pH, and a controlled ammonia concentration; and when a particle size of a reaction product reaches a target value, subjecting the reaction product to solid-liquid separation (SLS) to obtain a solid material;
S2: subjecting the solid material to calcination to obtain a calcined material; and
S3: soaking the calcined material in water, and separating a solid phase to obtain the cathode material precursor with a large channel.

In some embodiments of the present disclosure, in S1, the sodium hexanitrocobaltate aqueous solution may be prepared as follows: dissolving a soluble cobalt salt and sodium nitrite in water, and adding an oxidant and acetic acid to obtain the sodium hexanitrocobaltate aqueous solution. Further, the soluble cobalt salt may be at least one of a nitrate, a chloride, and a sulfate. A reaction equation for preparing sodium hexanitrocobaltate with the cobalt salt and sodium nitrite is as follows (hydrogen peroxide and oxygen are adopted as the oxidant, for example):

24NaNO₂+4Co(NO₃)₂+2H₂O₂+4HAc=4Na₃[Co(NO₂)₆]+8NaNO₃+4NaAc+4H₂O; and

24NaNO₂+4Co(NO₃)₂+O₂+4HAc=4Na₃[Co(NO₂)₆]+8NaNO₃+4NaAc+2H₂O.

In some embodiments of the present disclosure, in S1, a molar ratio of cobalt ions in the soluble cobalt salt to sodium ions in the sodium nitrite may be 1:(6-8). Further, a molar ratio of the acetic acid to the cobalt ions in the soluble cobalt salt may be (1-1.5):1; and a molar concentration of cobalt in the sodium hexanitrocobaltate aqueous solution may be 0.01 mol/L to 0.2 mol/L.

In some embodiments of the present disclosure, in S1, the oxidant may be at least one of hydrogen peroxide, oxygen, and air.

In some embodiments of the present disclosure, in S1, a total molar concentration of metal ions in the nickel-manganese mixed salt solution may be 0.01 mol/L to 2.0 mol/L.

In some embodiments of the present disclosure, in S1, the nickel-manganese mixed salt solution may be prepared by dissolving soluble salts of nickel and manganese in water; and the soluble salts of nickel and manganese may be at least one of a nitrate, a chloride, and a sulfate.

In some embodiments of the present disclosure, in S1, the oxalic acid may have a concentration of 0.01 mol/L to 0.5 mol/L; and the aqueous ammonia may have a concentration of 1.0 mol/L to 6.0 mol/L.

In some embodiments of the present disclosure, in S1, the reaction may be conducted at a temperature of 45° C. to 65° C., a pH of 8.1 to 8.3, and an ammonia concentration of 2.0 g/L to 5.0 g/L. A molar ratio of metal elements in the precursor is controlled by controlling addition flow rates of the sodium hexanitrocobaltate aqueous solution and the nickel-manganese mixed salt solution.

In some embodiments of the present disclosure, in S1, the particle size may reach a D50 of 2.0 μm to 15.0 μm.

In some embodiments of the present disclosure, in S2, the calcination may be conducted at 200° C. to 250° C. Further, the calcination may be conducted for 1 h to 4 h. The calcination may be conducted in an air or oxygen atmosphere.

In some embodiments of the present disclosure, in S3, a ratio of a volume of the water to a mass of the calcined material may be 5,000 to 8,000 L/t.

In some embodiments of the present disclosure, in S3, the soaking may be conducted for 1 h to 2 h.

The present disclosure also provides use of the preparation method described above in the preparation of an LIB.

According to a preferred embodiment of the present disclosure, the present disclosure at least has the following beneficial effects.
1. In the present disclosure, in order to prepare an LIB cathode material with a large channel and improve the lithium ion deintercalation ability of the material during a charge-discharge process, a ternary precursor with a large channel is prepared in a front-end process. Nickel, cobalt, and manganese are subjected to co-precipitation with sodium and ammonium, and then the sodium and ammonium is removed through sintering. Since sodium ions have a larger radius than lithium ions, with the removal of the sodium and ammonium, a relatively large ion channel is left in a nickel-cobalt-manganese precursor skeleton, which facilitates the deintercalation of lithium ions in a chemically-sintered cathode material. Reaction equations for the co-precipitation of nickel, cobalt, and manganese with sodium and ammonium are as follows:

Na₃[Co(NO₂)₆]+2NH₄⁺=(NH₄)₂Na[Co(NO₂)₆]↓+2Na⁺

Ni²⁺+C₂O₄²⁻=NiC₂O₄↓

Mn²⁺+C₂O₄²⁻=MnC₂O₄↓

Through the co-precipitation, a eutectic alloy is formed, the eutectic alloy is further sintered such that an ammonium group, a nitro group, and an oxalate group therein are decomposed into gases to obtain a calcined material of nickel, cobalt, manganese, and sodium oxides, and the calcined material is soaked in pure water to remove sodium, dried, sieved, and demagnetized to obtain the LIB cathode material precursor with a large channel.
2. A level of Li/Ni disordering is reduced by widening a diffusion channel of lithium ions to obtain a relatively stable crystal structure, which effectively inhibits the occurrence of harmful phase transition and significantly improves the rate performance and cycling performance of a cathode material.

Other aspects can be obvious upon reading and understanding the drawings and detailed description.

### BRIEF DESCRIPTION OF THE DRAWINGS

The drawings are used to provide a further understanding of the technical solution herein and form part of the description, and are used together with the examples of the present application to interpret the technical solution herein, and do not constitute a limitation on the technical solution herein. The present application is further described below in conjunction with the accompanying drawings and examples, wherein:

FIG. 1 is a scanning electron microscopy (SEM) image of the LIB cathode material precursor with a large channel prepared in Example 1 of the present disclosure.

### DETAILED DESCRIPTION

The concepts and technical effects of the present disclosure are clearly and completely described below in conjunction with examples, so as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Example 1

In this example, an LIB cathode material precursor with a large channel was prepared by the following specific process:
step 1: cobalt nitrate and sodium nitrite were mixed in a molar ratio of 1:6 and dissolved in pure water, and then hydrogen peroxide and acetic acid (a molar quantity of the acetic acid was equal to a molar quantity of cobalt ions) were added to prepare a sodium hexanitrocobaltate aqueous solution with a cobalt molar concentration of 0.01 mol/L;
step 2: nickel nitrate and manganese nitrate in a molar ratio of 8:1 were adopted as raw materials to prepare a nickel-manganese mixed salt solution in which a total molar concentration of metal ions was 0.09 mol/L;
step 3: an oxalic acid solution with a concentration of 0.01 mol/L was prepared as a precipitating agent, and aqueous ammonia with a concentration of 1.0 mol/L was prepared as a complexing agent;
step 4: pure water was added to a reactor until a stirring paddle at a bottom of the reactor was immersed, and stirring was started;
step 5: the sodium hexanitrocobaltate aqueous solution prepared in step 1, the nickel-manganese mixed salt solution prepared in step 2, and the oxalic acid solution and aqueous ammonia prepared in step 3 were concurrently fed into the reactor to allow a reaction, where the reaction in the reactor was conducted at a temperature of 45° C., a pH of 8.1 to 8.3, and an ammonia concentration of 2.0 g/L; a flow rate ratio of the sodium hexanitrocobaltate aqueous solution to the nickel-manganese mixed salt solution was controlled at 1:1; and a molar ratio of oxalic acid in the oxalic acid solution to total metal ions of nickel and manganese was 1:1;
step 6: when it was detected that a particle size D50 of a material in the reactor reached 10.5 μm, the feeding was stopped;
step 7: the material in the reactor was subjected to SLS to obtain a solid material;
step 8: the solid material was calcined in an oxygen atmosphere at 200° C. for 2 h to obtain a calcined material;
step 9: the calcined material was soaked in pure water for 1 h according to a pure water-calcined material ratio of 8,000 L/t, a resulting mixture was subjected to SLS to obtain a wet material, and the wet material was washed with pure water; and
step 10: the wet material was dried, sieved, and demagnetized to obtain the LIB cathode material precursor with a large channel.

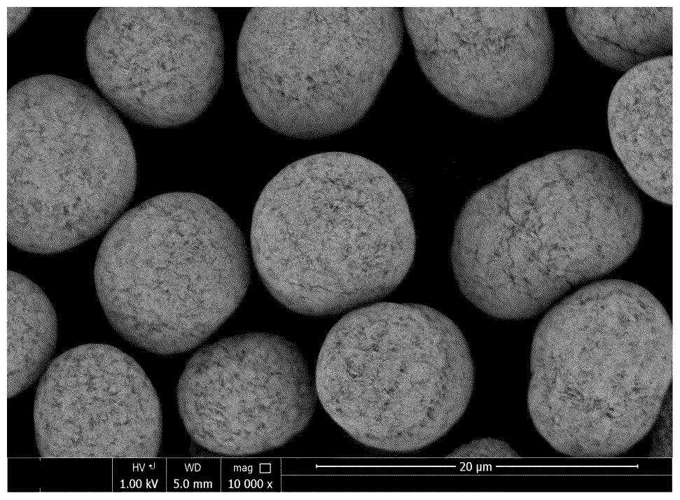

The precursor had a chemical formula of Ni_{0.8}Co_{0.1}Mn_{0.1}O. FIG. 1 was an SEM image of the LIB cathode material precursor with a large channel prepared in this example, and it can be seen from the FIGURE that the precursor had a spherical or spheroidic particle morphology, which can be used as a raw material for subsequent sintering to prepare a ternary cathode material.

### Example 2

In this example, an LIB cathode material precursor with a large channel was prepared by the following specific process:
step 1: cobalt sulfate and sodium nitrite were mixed in a molar ratio of 1:7 and dissolved in pure water, and then hydrogen peroxide and acetic acid (a molar quantity of the acetic acid was equal to a molar quantity of cobalt ions) were added to prepare a sodium hexanitrocobaltate aqueous solution with a cobalt molar concentration of 0.1 mol/L;
step 2: nickel sulfate and manganese sulfate in a molar ratio of 5:3 were adopted as raw materials to prepare a nickel-manganese mixed salt solution in which a total molar concentration of metal ions was 0.4 mol/L;
step 3: an oxalic acid solution with a concentration of 0.1 mol/L was prepared as a precipitating agent, and aqueous ammonia with a concentration of 3.0 mol/L was prepared as a complexing agent;
step 4: pure water was added to a reactor until a stirring paddle at a bottom of the reactor was immersed, and stirring was started;
step 5: the sodium hexanitrocobaltate aqueous solution prepared in step 1, the nickel-manganese mixed salt solution prepared in step 2, and the oxalic acid solution and aqueous ammonia prepared in step 3 were concurrently fed into the reactor to allow a reaction, where the reaction in the reactor was conducted at a temperature of 55° C., a pH of 8.1 to 8.3, and an ammonia concentration of 3.0 g/L; a flow rate ratio of the sodium hexanitrocobaltate aqueous solution to the nickel-manganese mixed salt solution was controlled at 1:1; and a ratio of oxalic acid in the oxalic acid solution to total metal ions of nickel and manganese was 1:1;
step 6: when it was detected that D50 of a material in the reactor reached 5.0 μm, the feeding was stopped;
step 7: the material in the reactor was subjected to SLS to obtain a solid material;
step 8: the solid material was calcined in an oxygen atmosphere at 250° C. for 3 h to obtain a calcined material;
step 9: the calcined material was soaked in pure water for 2 h according to a pure water-calcined material ratio of 6,000 L/t, a resulting mixture was subjected to SLS to obtain a wet material, and the wet material was washed with pure water; and
step 10: the wet material was dried, sieved, and demagnetized to obtain the LIB cathode material precursor with a large channel.

The precursor had a chemical formula of Ni_{0.5}Co_{0.2}Mn_{0.3}O, which had a spherical or spheroidic particle morphology and can be used as a raw material for subsequent sintering to prepare a ternary cathode material.

### Example 3

In this example, an LIB cathode material precursor with a large channel was prepared by the following specific process:
step 1: cobalt chloride and sodium nitrite were mixed in a molar ratio of 1:8 and dissolved in pure water, and then hydrogen peroxide and acetic acid (a molar quantity of the acetic acid was equal to a molar quantity of cobalt ions) were added to prepare a sodium hexanitrocobaltate aqueous solution with a cobalt molar concentration of 0.2 mol/L;
step 2: nickel chloride and manganese chloride in a molar ratio of 6:2 were adopted as raw materials to prepare a nickel-manganese mixed salt solution in which a total molar concentration of metal ions was 0.8 mol/L;
step 3: an oxalic acid solution with a concentration of 0.5 mol/L was prepared as a precipitating agent, and aqueous ammonia with a concentration of 6.0 mol/L was prepared as a complexing agent;
step 4: pure water was added to a reactor until a stirring paddle at a bottom of the reactor was immersed, and stirring was started;
step 5: the sodium hexanitrocobaltate aqueous solution prepared in step 1, the nickel-manganese mixed salt solution prepared in step 2, and the oxalic acid solution and aqueous ammonia prepared in step 3 were concurrently fed into the reactor to allow a reaction, where the reaction in the reactor was conducted at a temperature of 65° C., a pH of 8.1 to 8.3, and an ammonia concentration of 5.0 g/L; a flow rate ratio of the sodium hexanitrocobaltate aqueous solution to the nickel-manganese mixed salt solution was controlled at 1:1; and a ratio of oxalic acid in the oxalic acid solution to total metal ions of nickel and manganese was 1:1;
step 6: when it was detected that D50 of a material in the reactor reached 15.0 μm, the feeding was stopped;
step 7: the material in the reactor was subjected to SLS to obtain a solid material;
step 8: the solid material was calcined in an oxygen atmosphere at 200° C. for 4 h to obtain a calcined material;
step 9: the calcined material was soaked in pure water for 2 h according to a pure water-calcined material ratio of 5,000 L/t, a resulting mixture was subjected to SLS to obtain a wet material, and the wet material was washed with pure water; and
step 10: the wet material was dried, sieved, and demagnetized to obtain the LIB cathode material precursor with a large channel.

The precursor had a chemical formula of Ni_{0.6}Co_{0.2}Mn_{0.2}O, which had a spherical or spheroidic particle morphology and can be used as a raw material for subsequent sintering to prepare a ternary cathode material.

### Comparative Example 1

In this comparative example, a precursor Ni_{0.8}Co_{0.1}Mn_{0.1}O was prepared by the following specific process, which was different from the process in Example 1 in that the sodium hexanitrocobaltate aqueous solution was not prepared:
step 1: nickel nitrate, manganese nitrate, and cobalt nitrate in a molar ratio of 8:1:1 were adopted as raw materials to prepare a nickel-cobalt-manganese mixed salt solution in which a total molar concentration of metal ions was 0.1 mol/L;
step 2: an oxalic acid solution with a concentration of 0.01 mol/L was prepared as a precipitating agent, and aqueous ammonia with a concentration of 1.0 mol/L was prepared as a complexing agent;
step 3: pure water was added to a reactor until a stirring paddle at a bottom of the reactor was immersed, and stirring was started;
step 4: the nickel-cobalt-manganese mixed salt solution prepared in step 1 and the oxalic acid solution and aqueous ammonia prepared in step 2 were concurrently fed into the reactor to allow a reaction, where the reaction in the reactor was conducted at a temperature of 45° C., a pH of 8.1 to 8.3, and an ammonia concentration of 2.0 g/L; and a ratio of oxalic acid in the oxalic acid solution to total metal ions of nickel and manganese was 1:1;
step 5: when it was detected that a particle size D50 of a material in the reactor reached 10.5 μm, the feeding was stopped;
step 6: the material in the reactor was subjected to SLS to obtain a solid material;
step 7: the solid material was calcined in an oxygen atmosphere at 200° C. for 2 h to obtain a calcined material; and
step 8: the calcined material was sieved and demagnetized to obtain the precursor Ni_{0.8}Co_{0.1}Mn_{0.1}O.

### Comparative Example 2

In this comparative example, a precursor Ni_{0.5}Co_{0.2}Mn_{0.3}O was prepared by the following specific process, which was different from the process in Example 2 in that the sodium hexanitrocobaltate aqueous solution was not prepared:
step 1: nickel sulfate, manganese sulfate, and cobalt sulfate in a molar ratio of 5:2:3 were adopted as raw materials to prepare a nickel-cobalt-manganese mixed salt solution in which a total molar concentration of metal ions was 0.5 mol/L;
step 2: an oxalic acid solution with a concentration of 0.1 mol/L was prepared as a precipitating agent, and aqueous ammonia with a concentration of 3.0 mol/L was prepared as a complexing agent;
step 3: pure water was added to a reactor until a stirring paddle at a bottom of the reactor was immersed, and stirring was started;
step 4: the nickel-cobalt-manganese mixed salt solution prepared in step 1 and the oxalic acid solution and aqueous ammonia prepared in step 2 were concurrently fed into the reactor to allow a reaction, where the reaction in the reactor was conducted at a temperature of 55° C., a pH of 8.1 to 8.3, and an ammonia concentration of 3.0 g/L;
step 5: when it was detected that a particle size D50 of a material in the reactor reached 5.0 μm, the feeding was stopped;
step 6: the material in the reactor was subjected to SLS to obtain a solid material;
step 7: the solid material was calcined in an oxygen atmosphere at 250° C. for 3 h to obtain a calcined material; and
step 8: the calcined material was sieved and demagnetized to obtain the precursor Ni_{0.5}Co_{0.2}Mn_{0.3}O.

### Comparative Example 3

In this comparative example, a precursor Ni_{0.6}Co_{0.2}Mn_{0.2}O was prepared by the following specific process, which was different from the process in Example 3 in that the sodium hexanitrocobaltate aqueous solution was not prepared:
step 1: nickel chloride, manganese chloride, and cobalt chloride in a molar ratio of 6:2:2 were adopted as raw materials to prepare a nickel-cobalt-manganese mixed salt solution in which a total molar concentration of metal ions was 1.0 mol/L;
step 2: an oxalic acid solution with a concentration of 0.5 mol/L was prepared as a precipitating agent, and aqueous ammonia with a concentration of 6.0 mol/L was prepared as a complexing agent;
step 3: pure water was added to a reactor until a stirring paddle at a bottom of the reactor was immersed, and stirring was started;
step 4: the nickel-cobalt-manganese mixed salt solution prepared in step 1 and the sodium hydroxide solution and aqueous ammonia prepared in step 2 were concurrently fed into the reactor to allow a reaction, where the reaction in the reactor was conducted at a temperature of 65° C., a pH of 8.1 to 8.3, and an ammonia concentration of 5.0 g/L;
step 5: when it was detected that D50 of a material in the reactor reached 15.0 μm, the feeding was stopped;
step 6: the material in the reactor was subjected to SLS to obtain a solid material;
step 7: the solid material was calcined in an oxygen atmosphere at 200° C. for 4 h to obtain a calcined material; and
step 8: the calcined material was sieved and demagnetized to obtain the precursor Ni_{0.6}Co_{0.2}Mn_{0.2}O.

### Test Example

The precursor materials obtained in Examples 1 to 3 and Comparative Examples 1 to 3 were each sintered with a lithium source to prepare a ternary cathode material. The cathode material was subjected to an electrochemical performance test, and test results were shown in Table 1.

TABLE 1
Comparison of electrochemical performance of the precursors

| | Initial specific | Cycling capacity retention | Rate |
|---|---|---|---|
| | discharge capacity | rate at room temperature | performance |
| Material | at 0.1 C (mAh/g) | (1 C/1 C, 100 cycles) | (3 C/0.1 C) |
| Example 1 | 206.8 | 97.5% | 93.9% |
| Comparative | 206 | 91.2% | 90.5% |
| Example 1 | | | |
| Example 2 | 174 | 98.5% | 94.3% |
| Comparative | 173.2 | 92.5% | 90.5% |
| Example 2 | | | |
| Example 3 | 182.8 | 98.1% | 94.5% |
| Comparative | 182 | 92.6% | 91.3% |
| Example 3 | | | |

It can be seen from Table 1 that, compared with the precursors of the comparative examples, the precursors of the examples led to better cycling performance and rate performance. In the preparation of each of the precursors of the examples, co-precipitation was first conducted with sodium and ammonium; then sintering was conducted, such that an ammonium group, a nitro group, and an oxalate group therein were decomposed into gases to obtain a calcined material of nickel, cobalt, manganese, and sodium oxides; and the calcined material was soaked in pure water to remove sodium, such that a larger ion channel was left and a diffusion channel of lithium ions was widened in a nickel-cobalt-manganese precursor skeleton because sodium ions had a larger radius than lithium ions, which facilitated the deintercalation of lithium ions in a chemically-sintered cathode material, resulted in a more stable crystal structure, and significantly improved the rate performance and cycling performance of the material.

The present disclosure is above described in detail with reference to the accompanying drawings and examples, but the present disclosure is not limited to the above examples. Within the scope of knowledge possessed by those of ordinary skill in the technical field, various changes can also be made without departing from the purpose of the present disclosure. In addition, the examples in the present disclosure and features in the examples may be combined with each other in a non-conflicting situation.

1. A preparation method for a cathode material precursor with a large channel, comprising the following steps:
S1: mixing a sodium hexanitrocobaltate aqueous solution, a nickel-manganese mixed salt solution, an oxalic acid solution, and aqueous ammonia to allow a reaction at a controlled temperature, a controlled pH, and a controlled ammonia concentration; and when a particle size of a reaction product reaches a target value, subjecting the reaction product to solid-liquid separation (SLS) to obtain a solid material;
S2: subjecting the solid material to calcination to obtain a calcined material; and
S3: soaking the calcined material in water, and separating a solid phase to obtain the cathode material precursor with the large channel.

2. The preparation method according to claim 1, wherein in S1, the sodium hexanitrocobaltate aqueous solution is prepared as follows: dissolving a soluble cobalt salt and sodium nitrite in water, and adding an oxidant and acetic acid to obtain the sodium hexanitrocobaltate aqueous solution.

3. The preparation method according to claim 2, wherein in S1, a molar ratio of cobalt ions in the soluble cobalt salt to sodium ions in the sodium nitrite is 1:(6-8).

4. The preparation method according to claim 2, wherein in S1, the oxidant is at least one of hydrogen peroxide, oxygen, and air.

5. The preparation method according to claim 2, wherein in S1, a molar ratio of the acetic acid to cobalt ions in the soluble cobalt salt is (1-1.5):1.

6. The preparation method according to claim 2, wherein in S1, a molar concentration of cobalt in the sodium hexanitrocobaltate aqueous solution is 0.01 mol/L to 0.2 mol/L.

7. The preparation method according to claim 1, wherein in S1, a total molar concentration of metal ions in the nickel-manganese mixed salt solution is 0.01 mol/L to 2.0 mol/L.

8. The preparation method according to claim 1, wherein in S1, the oxalic acid has a concentration of 0.01 mol/L to 0.5 mol/L; and the aqueous ammonia has a concentration of 1.0 mol/L to 6.0 mol/L.

9. The preparation method according to claim 1, wherein in S1, the reaction is conducted at a temperature of 45° C. to 65° C., a pH of 8.1 to 8.3, and an ammonia concentration of 2.0 g/L to 5.0 g/L.

10. The preparation method according to claim 1, wherein in S1, the particle size D50 is 2.0 to 15.0.

11. The preparation method according to claim 1, wherein in S2, the calcination is conducted at 200° C. to 250° C.

12. The preparation method according to claim 1, wherein in S3, a ratio of a volume of the water to a mass of the calcined material is 5,000 to 8,000 L/t.

13. Use of the preparation method according to claim 1 in the preparation of a lithium-ion battery (LIB).

14. Use of the preparation method according to claim 2 in the preparation of a lithium-ion battery (LIB).

15. Use of the preparation method according to claim 7 in the preparation of a lithium-ion battery (LIB).

16. Use of the preparation method according to claim 8 in the preparation of a lithium-ion battery (LIB).

17. Use of the preparation method according to claim 9 in the preparation of a lithium-ion battery (LIB).

18. Use of the preparation method according to claim 10 in the preparation of a lithium-ion battery (LIB).

19. Use of the preparation method according to claim 11 in the preparation of a lithium-ion battery (LIB).

20. Use of the preparation method according to claim 12 in the preparation of a lithium-ion battery (LIB).
